(19) United States
(12) Patent Application Publication
(10) Pub. No.: US 2012/0225226 A1
(43) Pub. Date: Sep. 6, 2012

(54) Water-proof, removable and washable back pack cover

(76) Inventor: Albert Fikry, Cinnaminson, NJ (US)

(21) Appl. No.: 12/932,777

(22) Filed: Mar. 5, 2011

(51) Int. Cl. B32B 1/00

(52) U.S. Cl. 428/35.2

(57) ABSTRACT

A back pack cover that is functional. Waterproof and washable fabric is fashioned so that all sides of the back pack are covered except the rear of the back pack where an oval-shape cut out appears containing an elastic band surrounding the oval-shape cut out so that the shoulder straps can exit the cover and so that the cover fits over the back pack in a snug fashion but still permits the user to wear the back pack on his or her back.

### FIELD OF THE INVENTION

The present invention relates to a back pack cover and, more particularly, to a water-proof fabric, removable and washable back pack cover with an elastic band around an oval shaped opening in the rear of the cover that allows the shoulder straps of the back pack to exit the cover so that a user may wear the back pack on his or her back while the cover is on the back pack.

### BACKGROUND OF THE INVENTION

Anyone who has spent time at a bus stop can see that back packs end up on the dirty ground or getting soaked in the rain or snow as kids wait for the bus. Anyone who has tried to wash a back pack also knows that it is difficult to wash because of the fabric used to decorate the back packs including hard plastic and also to dry because of the tough and thick fabrics used in its manufacture.

There appear to be back pack covers for large camping style backpacks, they are not designed to cover school-book sized back packs and they do not appear to be easily removable or washable.

The camping back pack style back packs are very large to cover camping back packs and are closed with a drawstring with a knob that may be difficult for children to secure and remove. It does also not appear to be the case that these camping style backs are designed to be washable.

### SUMMARY OF THE INVENTION

In accordance with the present invention, there is provided a back pack cover that is functional. Waterproof and washable fabric is fashioned so that all sides of the back pack are covered except the rear of the back pack where an oval-shape cut out appears, where the shoulder straps of the back pack are located, with an elastic band contained around the the oval-shape cut out, so that the back pack cover will fit over the back pack in a snug fashion but still permit the user to wear the back pack on his or her back.

It would be advantageous to provide a back pack cover that is waterproof and washable.

It would also be advantageous to provide a back pack cover that can be secured and removed without aany clasps, hooks or ties.

It would further be advantageous to provide a back pack cover that enables the user to use the back pack cover while still being able to wear the back pack in a traditional fashion, on one's back.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of the back pack cover;

FIG. 2 is a rear perspective view of a back pack cover containing the oval shaped opening for the back pack straps to fit so as to allow the wearer to wear the back pack on his her back while simultaneously the back pack cover is utilized to cover the back pack; and

FIG. 3 is a left view of a person utilizing the back pack cover while wearing a back pack.

For purposes of clarity and brevity, like elements and components will bear the same designations and numbering throughout the Figures.

### DESCRIPTION OF THE PREFERRED EMBODIMENT

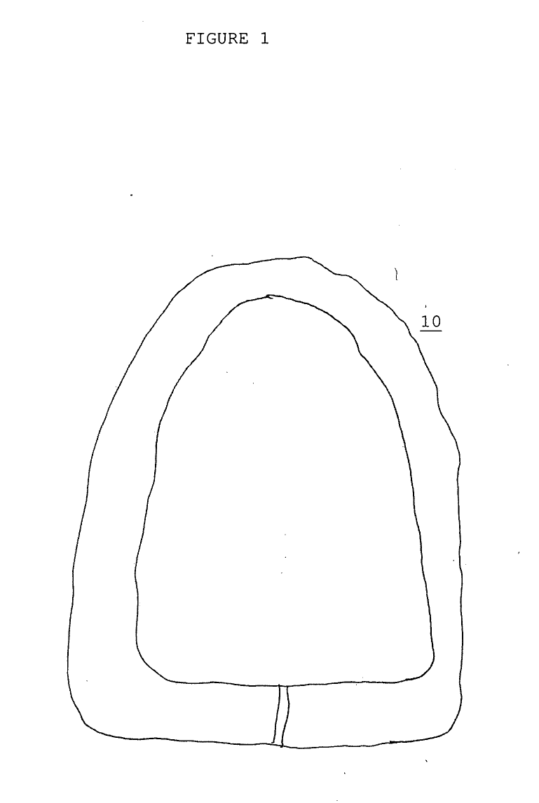

FIG. 1 is a front view of the back pack cover with number 10 refering to the washable, waterproof fabric covering the exterior of the back pack.

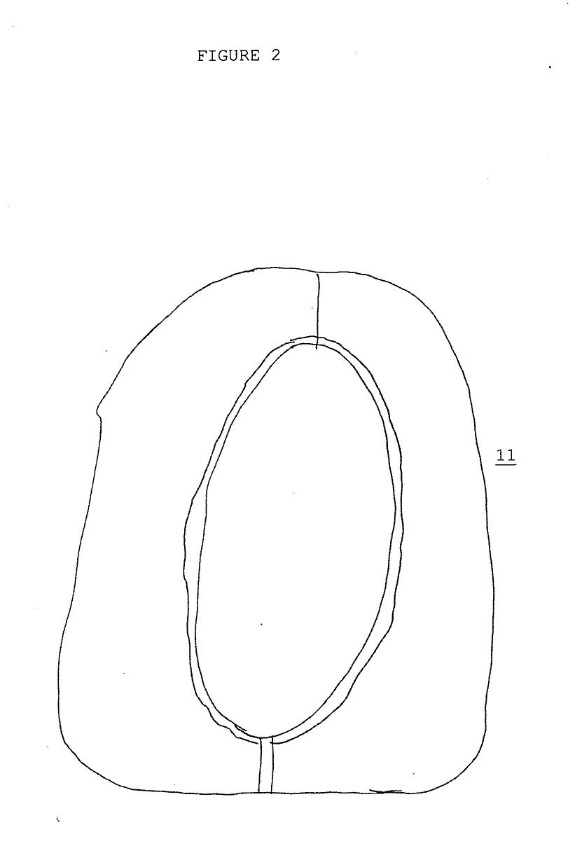

FIG. 2 is a rear perspective view of the back pack cover with number 11 referring to the elasticized seam around an oval shaped opening to allow for the back pack straps to exit the back pack cover so as to allow the wearer to wear the back pack on his her back while simultaneously allowing the back pack cover to cover the entire exterior of back pack except that part which is touching the user's back.

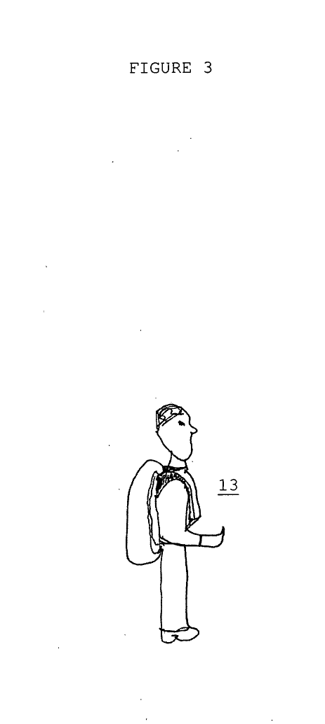

FIG. 3 is a left view of a person utilizing the back pack cover while wearing a back pack with Number 13 referring to the not claimed back pack shoulder straps 13.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A water-proof, removable and washable back pack cover for the covering of a back pack which can adhere to the back pack and be removed to prevent that back pack from becoming wet, dirty or damaged while allowing the user to still wear the back pack on his or her back, comprising:
means for the complete covering of the exterior surface of a back pack; and
means for stretching when removing the cover and contracting when the cover is placed on the back pack so that the cover fits snugly over the the back pack and allowing the shoulder straps of the back pack to exit the cover.

2. The water-proof, removable and washable back pack cover in accordance with claim 1, wherein said means for the complete covering of the exterior surface of a back pack comprises a new attribute washable and waterproof fabric cover.

3. The water-proof, removable and washable back pack cover in accordance with claim 1, wherein said means for stretching when removing the cover and contracting when the cover is placed on the back pack so that the cover fits snugly over the the back pack and allowing the shoulder straps of the back pack to exit the cover comprises a new attribute 2 oval-shape cut out with elastic band in seam.
